(19) United States
(12) Patent Application Publication
(10) Pub. No.: US 2006/0200775 A1
(43) Pub. Date: Sep. 7, 2006

(54) Displaying a plurality of selection areas in a computer-implemented graphical user interface

(76) Inventors: Jay A. Behr, San Francisco, CA (US); Daniel L. Thompson, Hutto, TX (US); Benjamin B. Cronin, San Francisco, CA (US)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 11/069,670

(22) Filed: Mar. 1, 2005

(51) Int. Cl. G06F 9/00; G06F 17/00

(52) U.S. Cl. 715/767; 715/803; 715/802; 715/781

(57) ABSTRACT

A computer-implemented graphical user interface for displaying a plurality of selection areas. A first selection are is displayed on a monitor attached to the computer, and then a second selection area is displayed on the monitor attached to the computer without erasing the first selection area. The first and/or second selection areas are modified to visually distinguish between the first and second selection areas, wherein the first and/or second selection areas are modified to have different colors, fills, patterns or lines. Finally, either the first or second selection area may be selected as an active selection area.

### BACKGROUND OF THE INVENTION

1. Field of the Invention

The present invention relates generally to computer-implemented graphics systems, and in particular, to a method, apparatus, and article of manufacture for displaying a plurality of selection areas in a computer-implemented graphical user interface.

2. Description of the Related Art

In a computer-implemented program with a graphical user interface (GUI), a user will frequently select areas of a two-dimensional image or display for viewing, object selection, etc. This is usually done by using the mouse to draw a selection area, such as a selection rectangle.

For example, when drawing a selection rectangle, the user may “pick” or select two opposing corners to define the area of the selection rectangle. Thereafter, a preview of the selection area is often displayed, sometimes using a dashed or dotted line to represent boundaries of the selection area. This preview provides feedback during and after the selection.

Sometimes, when a first selection area is displayed, the user must pick a second selection area, usually to refine the first selection area, but sometimes for other purposes. In these cases, it would be helpful for the user to be able to see the boundaries of both the first and second selection areas at the same time. In the prior art, however, the first selection area simply disappears once the user begins to define a second selection area.

Consequently, there is a need in the art for improved techniques for providing visual cues in a computer-implemented graphical user interface in the display of two or more selection areas. Specifically, there is a need in the art for a method of displaying a plurality of selection areas in a computer-implemented graphical user interface.

### SUMMARY OF THE INVENTION

To address the requirements described above, the present invention discloses a method, apparatus, and article of manufacture for displaying a plurality of selection areas in a computer-implemented graphical user interface. A first selection area is displayed on a monitor attached to the computer, and then a second selection area is displayed on the monitor attached to the computer without erasing the first selection area. The first and/or second selection areas are modified to visually distinguish between the first and second selection areas on the monitor attached to the computer, wherein the first and/or second selection areas are modified to have different colors, fills, patterns or lines. Finally, either the first or second selection area is selected as an active area on the monitor attached to the computer.

### BRIEF DESCRIPTION OF THE DRAWINGS

Referring now to the drawings in which like reference numbers represent corresponding parts throughout:

FIG. 1 is an exemplary hardware and software environment used to implement the preferred embodiment of the invention;

FIG. 2 illustrates an example display of a plurality of selection areas on a monitor according to the preferred embodiment of the present invention; and

FIGS. 3, 4 and 5 are flowcharts that illustrates the logic of the preferred embodiment of the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

The present invention is a computer-implemented system that displays a plurality of selection areas in a graphical user interface. First and second selection areas are simultaneously displayed on a monitor attached to the computer. The first and/or second selection areas are modified to visually distinguish between them, using different colors, fills, patterns or lines. Either the first or second selection area may be selected as the active area.

Hardware and Software Environment

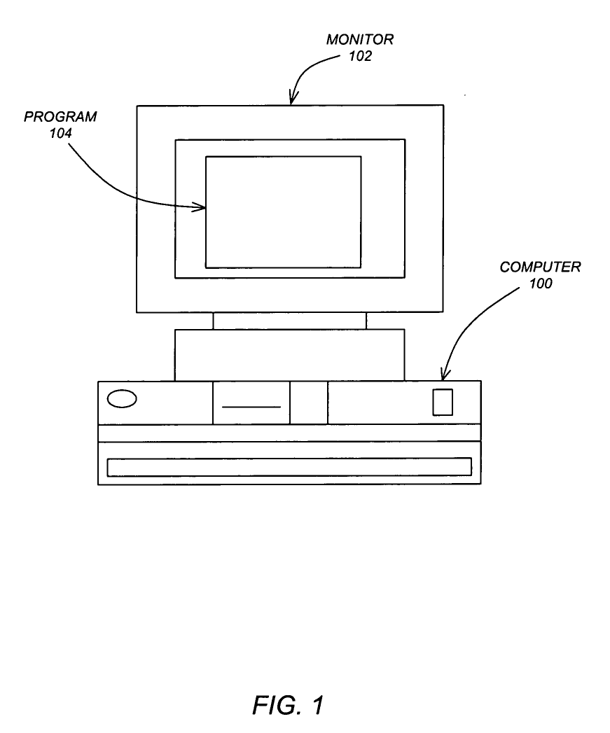

FIG. 1 is an exemplary hardware and software environment used to implement the preferred embodiment of the invention. The preferred embodiment of the present invention is typically implemented using a computer 100, which generally includes, inter alia, a monitor 102, and other devices. Those skilled in the art will recognize that any combination of the above components, or any number of different components, peripherals, and other devices, may be used with the computer 100.

The preferred embodiment of the present invention is implemented by a computer-implemented program 104 that is represented by a window displayed on the monitor 102. Generally, the program 104 comprises logic and/or data embodied in or readable from a device, media, or carrier, e.g., one or more fixed and/or removable data storage devices connected directly or indirectly to the computer 100, one or more remote devices coupled to the computer 100 via a data communications devices, etc.

Those skilled in the art will recognize that the exemplary environment illustrated in FIG. 1 is not intended to limit the present invention. Indeed, those skilled in the art will recognize that other alternative environments may be used without departing from the scope of the present invention.

Selection Areas

Within the program 104 window, the user will frequently select areas of the program 104 window for viewing, object selection, etc. This is usually done by using a mouse to draw a selection area, such as a selection rectangle, although other shapes may be used.

Sometimes, when a first selection area is displayed, the user needs to draw or define a second selection area, usually to refine the first selection area, but for other purposes as well. In these cases, it would be helpful for the user to be able to display both the first and second selection areas simultaneously. Specifically, it would be helpful if the user could display a second selection area without erasing the first selection area.

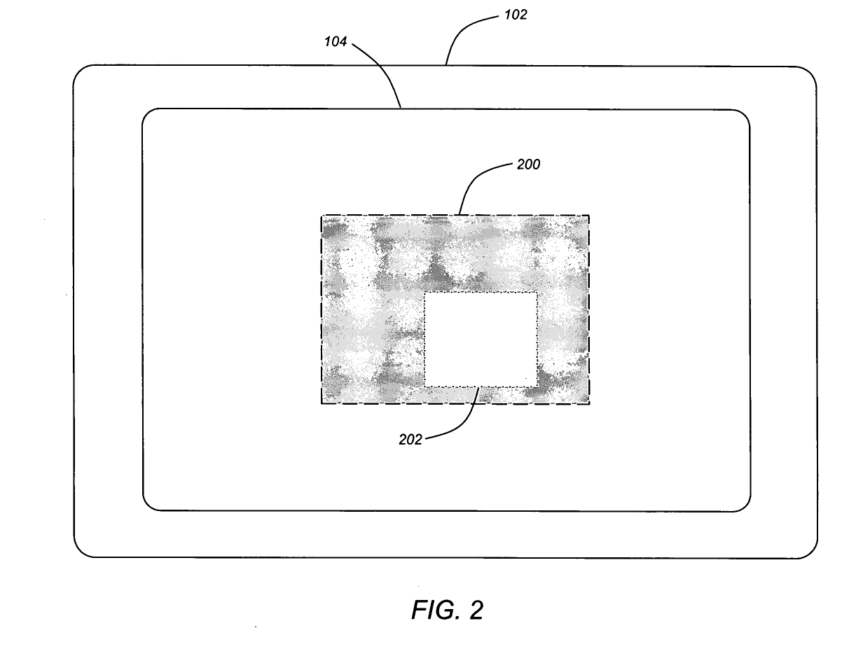

FIG. 2 illustrates an example display of a plurality of selection areas 200 and 202 within a program 104 window displayed on a monitor 102 according to the preferred embodiment of the present invention.

To select an area of the window, the user will use the mouse to draw the first selection area 200, which is shown as a selection rectangle. When drawing the first selection area 200, the user picks or selects two opposing corners to define the area of the selection rectangle. Thereafter, a preview of the first selection area 200 is displayed, using a dashed line to represent boundaries of the first selection area 200.

While the first selection area 200 remains displayed, the user selects another area of the window, by using the mouse to draw the second selection area 202, which is also shown as a selection rectangle. When drawing the second selection area 202, the user picks or selects two opposing corners to define the area of the selection rectangle. Thereafter, a preview of the second selection area 202 is displayed, using a dotted line to represent boundaries of the second selection area 202.

In the present invention, the program 104 displays both the first selection area 200 and second selection area 202 simultaneously on the monitor 102. The user is able to see the boundaries of both the first and second selection areas 200, 202 at the same time, because the first selection area 200 is not erased when the user defines the second selection area 202.

Consequently, using the present invention, the user can select either the first selection area 200 or the second selection area 202. Once selected, the first or second selection areas 200, 202 become the active selection area.

Preferably, the first and second selection areas 200, 202 are visually different from each other, in order to distinguish between the first selection area 200 and the second selection area 202 when both are displayed on the monitor 102. For example, FIG. 2 illustrates that a portion of the first selection area 200 not within the second selection area 202 may be visually indicated by a grey mask, while the entire second selection area 202 may be visually indicated by a white mask.

Other methods of visually distinguishing the first and second selection areas 200, 202 may be used as well. Specifically, the first and/or second selection areas 200, 202 may be modified to have different colors, fills, patterns or lines.

Moreover, more than two selection areas may be simultaneously displayed. In such an embodiment, each selection area may have a different visual effect or the same visual effect. Moreover, the visual effect may be used to indicate an effective age of the selection areas, i.e., which selection areas are the oldest, next oldest, . . . , newest, etc.

Finally, the selection areas may not be rectangles. Indeed, any enclosed shapes may be used to specify selection areas.

Logic of the Program

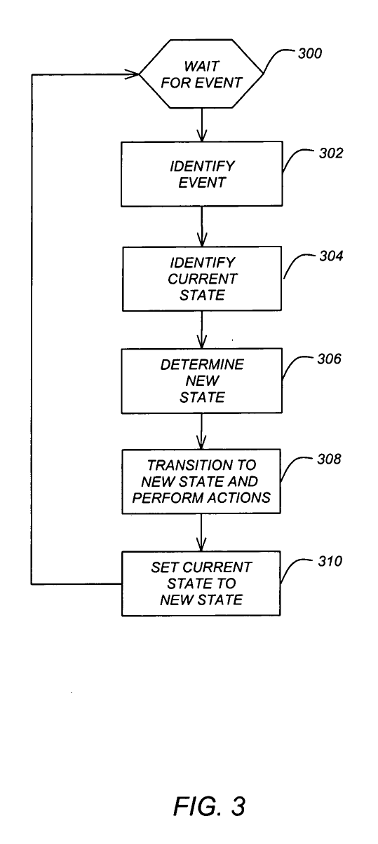

Flowcharts which illustrate the logic of the program 104 according to the preferred embodiment of the present invention are shown in FIGS. 3, 4 and 5. Those skilled in the art will recognize that this logic is provided for illustrative purposes only and that different logic may be used to accomplish the same results.

FIG. 3 is a flowchart that illustrates the general logic of a message or event-driven program 104 performing the steps of the preferred embodiment of the present invention. In such a program 104, operations are performed when transitions are made, based upon the receipt of messages or events, from present or current states to new states.

Generally, the flowchart begins by waiting at Block 300 for an event (e.g., a mouse button click). It should be appreciated that, during this time, other tasks, e.g., file, memory, and video tasks, etc., may also be carried out. When an event occurs, control passes to Block 302 to identify the event. Based upon the event, as well as the current state of the program 104 determined in Block 304, a new state is determined in Block 306. In Block 308, the logic transitions to the new state and performs any actions required for the transition. In Block 310, the current state is set to the previously determined new state, and control returns to Block 300 to wait for more events.

The specific operations that are performed by Block 308 when transitioning between states will vary depending upon the current state and the event. The various operations required to implement and maintain the preferred embodiment of the present invention represent particular events handled by the logic. However, it should be appreciated that these operations represent merely a subset of all of the events handled by the computer 100.

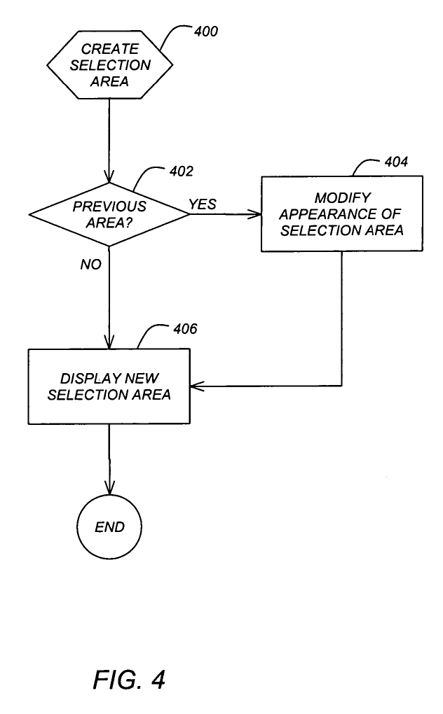

FIG. 4 is a flowchart that illustrates the general logic that is performed during the definition of a selection area according to the preferred embodiment of the present invention.

The logic begins at Block 400 when a new selection area is created by a user by means of a mouse or keyboard action, or by some other manner.

Block 402 is a decision block that represents the program 104 determining whether there is a previous selection area already displayed. If so, control transfers to Block 404; otherwise, control transfers to Block 406.

Block 404 represents the program 104 modifying the appearance of the previous selection area to visually distinguish it from the new selection area. Alternatively, Block 404 may represent the program 104 modifying the appearance of the new selection area to visually distinguish it from the previous selection area.

Block 406 represents the program 104 displaying the new selection area on the monitor 102.

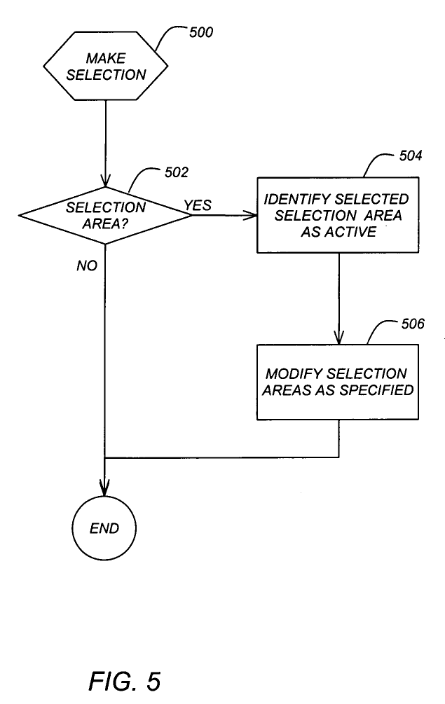

FIG. 5 is a flowchart that illustrates the general logic that is performed when selecting a selection area according to the preferred embodiment of the present invention.

The logic begins at Block 500 when a selection within the program 104 window is made by a user by means of a mouse or keyboard action, or by some other manner.

Block 502 is a decision block that represents the program 104 determining whether the user has selected a selection area. If so, control transfers to Block 504; otherwise, the logic terminates.

Block 504 represents the program 104 identifying the selected selection area as the active or current selection area.

Block 506 represents the program 104 modifying the appearance of one or more other selection areas to visually distinguish them from the active or current selection area. Alternatively, Block 506 may represent the program 104 modifying the appearance of the active or current selection area to visually distinguish it from the other selection areas. Alternatively, Block 506 may not perform any modifications to the appearance of the selection areas.

Thereafter, the logic terminates.

### CONCLUSION

This concludes the description of the preferred embodiment of the invention. The following describes some alternative embodiments for accomplishing the present invention.

For example, any type of computer, such as a mainframe, minicomputer, work station or personal computer, could be used with the present invention. In addition, any program, function, or operating system providing a graphical user interface could benefit from the present invention.

In summary, the present invention discloses a method, apparatus, and article of manufacture for displaying a plurality of selection areas. A first selection are is displayed on a monitor attached to the computer, and then a second selection area is displayed on the monitor attached to the computer without erasing the first selection area. The first and/or second selection areas are modified to visually distinguish between the first and second selection areas, wherein the first and/or second selection areas are modified to have different colors, fills, patterns or lines. Finally, either the first or second selection area may be selected as an active selection area.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for displaying a plurality of selection areas in a computer-implemented graphical user interface, comprising:
(a) displaying a first selection area on a monitor attached to the computer; and
(b) displaying a second selection area on the monitor attached to the computer without erasing the first selection area.

2. The method of claim 1, wherein the first and second selection areas are visually different from each other, in order to distinguish between the first selection area and the second selection area when both are displayed on the monitor.

3. The method of claim 2, further comprising modifying the first or second selection areas to visually distinguish between the first and second selection areas on the monitor attached to the computer.

4. The method of claim 2, wherein the first or second selection areas have different colors, fills, patterns or lines.

5. The method of claim 1, wherein the first and second selection areas are enclosed shapes.

6. The method of claim 1, further comprising selecting either the first or second selection area on the monitor attached to the computer.

7. The method of claim 6, wherein the selected first or second selection area is an active selection area.

8. The method of claim 1, further comprising simultaneously displaying more than two selection areas on the monitor attached to the computer.

9. The method of claim 8, wherein each selection area has a different visual effect.

10. The method of claim 8, wherein each selection area has a same visual effect.

11. The method of claim 8, wherein each selection area has a visual effect that indicates a relative age of the selection areas.

12. A computer-implemented apparatus for displaying a plurality of selection areas in a computer-implemented graphical user interface, comprising:
a computer having a monitor attached thereto;
logic, performed by the computer, for:
(a) displaying a first selection area on a monitor attached to the computer; and
(b) displaying a second selection area on the monitor attached to the computer without erasing the first selection area.

13. The apparatus of claim 12, wherein the first and second selection areas are visually different from each other, in order to distinguish between the first selection area and the second selection area when both are displayed on the monitor.

14. The apparatus of claim 13, further comprising logic for modifying the first or second selection areas to visually distinguish between the first and second selection areas on the monitor attached to the computer.

15. The apparatus of claim 13, wherein the first or second selection areas have different colors, fills, patterns or lines.

16. The apparatus of claim 12, wherein the first and second selection areas are enclosed shapes.

17. The apparatus of claim 12, further comprising logic for selecting either the first or second selection area on the monitor attached to the computer.

18. The apparatus of claim 17, wherein the selected first or second selection area is an active selection area.

19. The apparatus of claim 12, further comprising logic for simultaneously displaying more than two selection areas on the monitor attached to the computer.

20. The apparatus of claim 19, wherein each selection area has a different visual effect.

21. The apparatus of claim 19, wherein each selection area has a same visual effect.

22. The apparatus of claim 19, wherein each selection area has a visual effect that indicates a relative age of the selection areas.

23. An article of manufacture embodying logic for displaying a plurality of selection areas in a computer-implemented graphical user interface, the logic comprising:
(a) displaying a first selection area on a monitor attached to the computer; and
(b) displaying a second selection area on the monitor attached to the computer without erasing the first selection area.

24. The article of claim 23, wherein the first and second selection areas are visually different from each other, in order to distinguish between the first selection area and the second selection area when both are displayed on the monitor.

25. The article of claim 24, further comprising modifying the first or second selection areas to visually distinguish between the first and second selection areas on the monitor attached to the computer.

26. The article of claim 24, wherein the first or second selection areas have different colors, fills, patterns or lines.

27. The article of claim 23, wherein the first and second selection areas are enclosed shapes.

28. The article of claim 23, further comprising selecting either the first or second selection area on the monitor attached to the computer.

29. The article of claim 28, wherein the selected first or second selection area is an active selection area.

30. The article of claim 23, further comprising simultaneously displaying more than two selection areas on the monitor attached to the computer.

31. The article of claim 30, wherein each selection area has a different visual effect.

32. The article of claim 30, wherein each selection area has a same visual effect.

33. The article of claim 30, wherein each selection area has a visual effect that indicates a relative age of the selection areas.
